(19) United States
(12) Patent Application Publication
(10) Pub. No.: US 2002/0166240 A1
(43) Pub. Date: Nov. 14, 2002

(54) Power work tools having a slim profile

(75) Inventors: James David Duford, Polson, MT (US); Matthew B. Jore, Ronan, MT (US); David R. Samsel, Missoula, MT (US); Michael Alan Kvam, Polson, MT (US); Chad Michael Komlofske, Polson, MT (US); Nathan Cary Cantlon, Ronan, MT (US); Brian Patrick Havlovick, Polson, MT (US); Jack Howard Bishop, Ronan, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Jore Corporation

(21) Appl. No.: 09/973,200

(22) Filed: Apr. 12, 2001

Related U.S. Application Data
(60) Provisional application No. 60/196,627, filed on Apr. 12, 2000.

(51) Int. Cl. B23D 47/12

(52) U.S. Cl. 30/277.4; 30/388

(57) ABSTRACT

A power tool (20) is provided. The power tool includes a housing (22), a base plate (28) coupled to the housing and having a base plate width. The power tool also includes a motor assembly (24) attached to the housing and coupled to a tool connector adapted to releasably receive a tool (74). The motor assembly and housing having a width W that is at most substantially equal to the base plate width. Further, the motor assembly having a length (86) and diameter (84) ratio that is at least 1:1.5.

### CROSS-REFERENCE TO RELATED APPLICATION

This application claims the benefit of U.S. Provisional Patent Application Serial No. 60/196,627, filed Apr. 12, 2000, the disclosure of which is hereby expressly incorporated by reference.

### FIELD OF THE INVENTION

The present invention relates generally to hand held power tools and, more particularly, to power tools having a slim profile.

### BACKGROUND OF THE INVENTION

Hand held power tools, such as circular saws, generally include a motor attached to a housing and a connector to releasably attach and drive a tool, such as a saw blade. The motor may either be connected to a power outlet by an electric cord, or may be battery driven and are adapted to perform work on a work piece, such as lumber. The motor is usually a large cylindrical AC motor that has an axial length substantially larger than its diameter.

The motor may be mounted in one of two configurations. The first configuration generally positions the motor adjacent the tool. As an example, in a circular saw, the motor output axis is perpendicular to a plane extending through the diameter of the saw blade. Hand tools of this first configuration are typically ten inches wide due mainly to the length of the motor projecting from one side of the housing.

The second configuration is typically known as a worm drive tool. The most common of these hand tools are worm drive circular saws. These saws have a motor output axis that is parallel to a plane extending through the diameter of the saw blade. The width of a worm drive saw is usually 6-8 inches. Although large cylindrical motors are efficient, they are not without their problems.

The size and weight of large motors, the center of gravity of which is typically disposed on one side of the saw blade, makes such tools heavy and awkward. The large motor also makes it difficult for the operator to view each side of the work piece during use of the hand tool.

Cordless power tools, such as saws, include the use of small efficient DC motors. Although smaller motors can help reduce the weight of the tool, they too are not without their problems. As is well known, cordless saws typically have small diameter blades because the batteries in such motors cannot drive a larger blade for a satisfactory time period, or with enough torque to make them useful.

Increases in battery and motor voltages have allowed traditional size saw blades to be used in a cordless saw that is powerful enough to do useful work. However, the weight of the battery is considerable in order to provide an acceptable run time of the saw. Also, current cordless saw designs resemble traditional saws; that is, such saws include a cylindrical motor with a motor output axis perpendicular to the plane of the saw blade. As a result, such saws have a width that is similar to AC driven saws. The size and weight of the cylindrical motors substantially to one side of the plane of the saw blade can make them awkward to use and restrict the operators visibility of the work piece.

Thus, there exists a need for a hand tool having a slim profile and produces a sufficient amount of torque to drive traditional size tool pieces, such as saw blades.

### SUMMARY OF THE INVENTION

In accordance with one embodiment of the present invention, a power tool is provided. The power tool includes a housing, a base plate coupled to the housing and having a base plate width, and a motor assembly attached to the housing. The motor is coupled to a tool connector adapted to releasably receive a tool. The motor assembly and housing have a width that is at most substantially equal to the base plate width. The motor assembly includes a length and a diameter ratio that is at least 1:1.5. In one embodiment of the invention, the motor assembly length and diameter is substantially 1 inch and 4.5 inches, respectively. In still yet another embodiment of the invention, the base plate width is substantially 5 inches.

In accordance with further aspects of the present embodiment, the motor assembly and housing are pivotably attached to the base plate for selective swinging motion of the motor assembly and housing within a predetermined range of motion. One such example of the predetermined range of motion is substantially between 51° from a plane extending normal to the baseplate width and −40° from the plane. In still yet another example, the predetermined range of motion is substantially between the plane and up to 50° from the plane.

In accordance with still yet other aspects of this embodiment, the motor includes a printed circuit board disposed between first and second coil assemblies. Each coil assembly includes a plurality of coils, where adjacent coils are nested within each other. The printed circuit board further includes a plurality of coil connections in communication with the plurality of coils.

In accordance with still yet other aspects of this embodiment, the power tool includes an adjustable exhaust assembly integrally formed with housing, wherein a portion of the adjustable exhaust assembly is rotatably disposed within the housing and positionable between at least two exhaust positions.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a side planar view of a power hand tool formed in accordance with one embodiment of the present invention and illustrated as a circular saw;

FIG. 2 is a front end planar view of the circular saw of FIG. 1;

FIG. 3 is an exploded view of a circular saw formed in accordance with one embodiment of the present invention;

FIG. 4 is an exploded view of a motor assembly and saw blade assembly for a circular saw formed in accordance with one embodiment of the present invention;

FIG. 5 is an exploded view of a motor assembly for a circular saw formed in accordance with one embodiment of the present invention;

FIG. 6 is a cross sectional end view of the motor assembly of FIG. 5;

FIG. 7 is a perspective view of a coil for a motor of a circular saw formed in accordance with one embodiment of the present invention;

FIG. 8 is a planar view of a coil assembly for a circular saw formed in accordance with one embodiment of the present invention;

FIG. 9 is a cross section planar view of the coil assembly of FIG. 8 and taken substantially through Section 9-9;

FIG. 10 is a perspective view of a circular saw formed in accordance with one embodiment of the present invention and showing an exhaust assembly partially exploded from the circular saw;

FIG. 11 is a side plane view of a portion of the exhaust assembly of FIG. 10;

FIG. 12 is a cross sectional planar view of the exhaust assembly and taken substantially through Section 12-12;

FIG. 13 is a partial perspective view of a circular saw formed in accordance with one embodiment of the present invention and having a portion of the circular saw housing removed for clarity to show an alternate embodiment of an exhaust assembly;

FIG. 14 is a perspective view of a valve for the alternate exhaust assembly of FIG. 13;

FIG. 15 is a front planar view of a circular saw formed in accordance with one embodiment of the present invention in showing a tilting feature of the circular saw;

FIG. 16 is a front planar view of the circular saw of FIG. 15 and showing the circular saw displaced in a direction opposite from that illustrated in FIG. 15; and

FIG. 17 is a perspective view of a circular saw formed in accordance with another embodiment of the present invention and showing shoe extensions.

### DETAILED DESCRIPTION OF THE PREFERRED EMBODIMENT

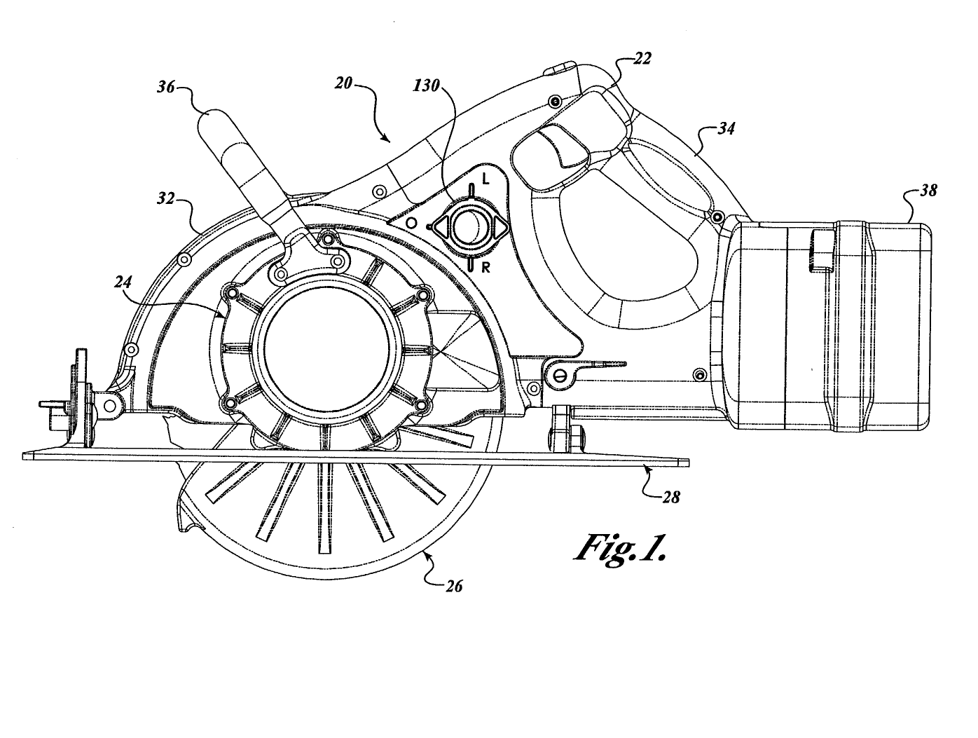

FIGS. 1-3 illustrate one embodiment of a hand held power tool, illustrated as a circular saw 20, formed in accordance with one embodiment of the present invention. Although the present embodiment is illustrated as a circular saw 20, the invention is not intended to be so limited. As an example, the principles of the present design may be applied to additional power tools, such as sanders or routers. Accordingly, it should be apparent that a circular saw is intended to be an illustrative example of the present invention and other power tools are also within the scope of the present invention.

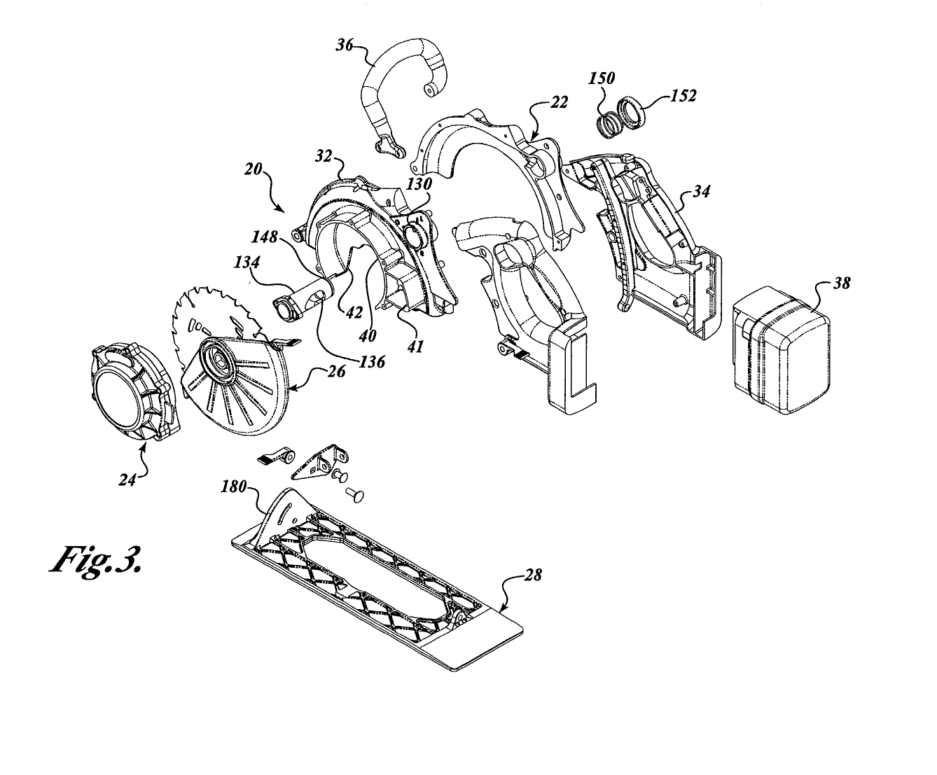

The circular saw 20 includes a housing 22, a motor assembly 24, a blade assembly 26, and a base plate 28. As may be best seen by referring to FIG. 3, the housing 22 includes a blade cover 32, an integral handle assembly 34, and an external handle 36.

The blade cover 32 and integral handle assembly 34 are suitably formed in a manner well known in the art and may be formed as first and second halves. The first and second halves of both the blade cover 32 and integral handle assembly 34 may be joined by well known fasteners (not shown), such as screws. A well known power pack 38, such as a battery pack, may be suitably attached to one end of the housing 22 to provide power to the motor assembly 24. Although a cordless, battery operated power tool is illustrated, it should be apparent that other sources of power, such as an AC power supply cable, are also within the scope of the present invention.

Referring now to FIGS. 3-6, the motor assembly 24 will now be described in greater detail. The motor assembly 24 may be attached to one side of the housing 22 on a motor support flange 40 projecting from one side of the housing 22. Located adjacent the motor support flange 40 is an electronics compartment 41. The electronics compartment 41 is adapted to store electronic components, as is well known in the art.

Integrally formed within the motor support flange 40 a cutout 42. The cutout 42 allows the motor assembly 24 to interface with the interior of housing 22. Cutout 42 is shaped to match a gear cover 44. It should be understood by those of ordinary skill in the art that the saw 20 can alternately have a motor assembly 24 mounted to the right side of saw 20.

The motor assembly 24 includes an outer motor shell 46, an inner motor shell 48, and a motor output shaft 50 rotatably supported by bearings 52 and 54. The motor assembly 24 also includes an arbor 56 rotatably supported by a first shaft bushing 58 held by the inner motor shell 48 and a second shaft bushing 60 held by the gear cover 44. A reduction gear 62 is affixed to arbor 56 in a well known manner. Motor output shaft 50 engages the reduction gear 62 to rotatably drive the arbor 56. The motor assembly 24 preferably has a power output as measured at arbor 56 that is one horsepower or greater.

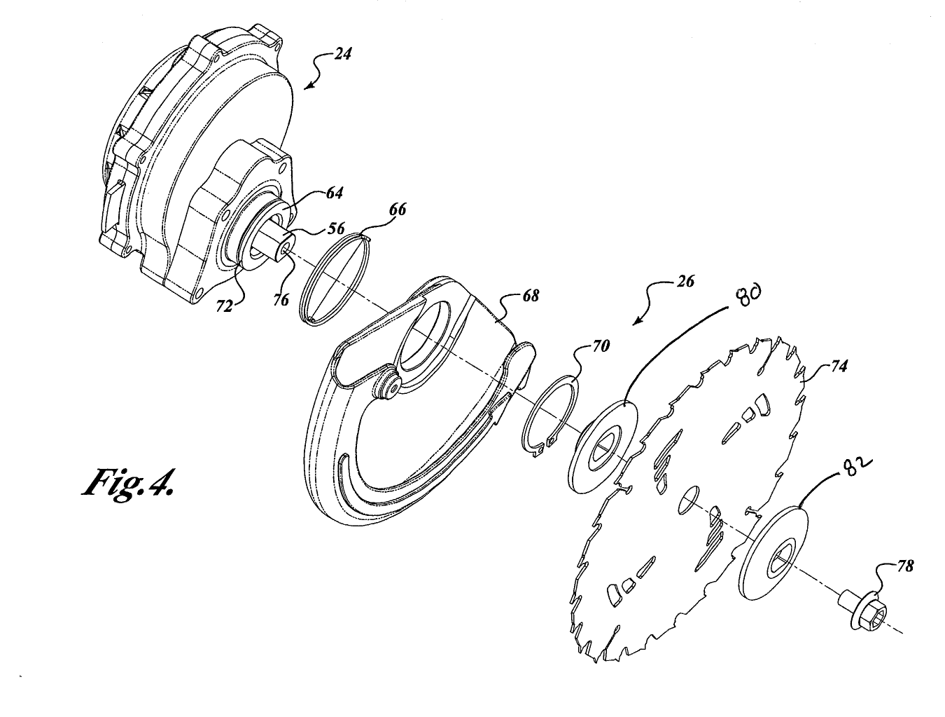

As seen best by referring to FIG. 4, the gear cover 44 has an annular boss 64 concentric around arbor 56. The annular boss 64 is adapted to receive the blade assembly 26. The blade assembly 26 includes a blade guard return spring 66, a lower blade guard 68, a retainer clip 70, a blade 74, and a bolt 78.

The blade guard return spring 66 fits loosely over annular boss 64. The lower blade guard 68 fits slidably over annular boss 64 to trap the spring 66. The retainer clip 70 snaps into a retainer groove 72 to keep the lower blade guard 68 on the boss 64. The spring 66 biases the lower blade guard 68 to enclose the lower portion of blade 74.

Arbor 56 has threaded bore 76 for receiving the blade bolt 78. An inner blade bushing 80 and an outer blade bushing 82 sandwich circular saw blade 74 on arbor 56 and are tensioned by the blade bolt 78. Bushings 80 and 82 are keyed to the arbor 56 and frictionally prevent the blade 74 from slipping with respect to the arbor 56. As assembled on the arbor 56, an axis extending through the length of the motor output shaft 50 is substantially normal to a plane extending through and parallel with the diameter of the saw blade 74. Specifically, the axis extending through the motor output shaft 50 is normal to the diameter of the saw blade and is contained within the diameter of the saw blade.

As seen best by referring to FIG. 6, the motor assembly 24 includes a diameter 84 and an axial length 86, where the diameter 84 that is greater than the axial length 86 by a predetermined amount. The axial length 86 of motor assembly 24 is also significantly less than the axial length of equivalent power motors of prior art circular saws. In one embodiment of the present invention, the motor assembly 24 has an axial length 86 and diameter 84 ratio that is at least 1:1.5. As a non-limiting example, the axial length 86 of the motor assembly 24 is one inch, while the diameter 84 is 4.5 inches.

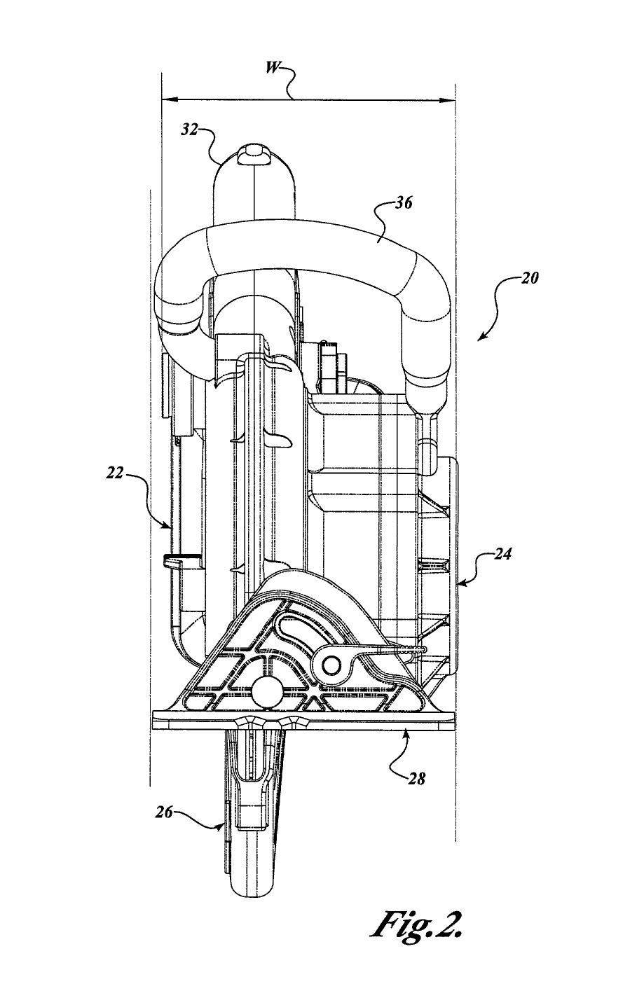

A motor assembly 24 formed in accordance with the embodiments of the present invention allows the saw 20 to have a width that is less than the width of prior art circular saws. As seen best by referring back to FIG. 2, the width of the motor assembly 24 and housing 22 is indicated by the letter W. The width of the base plate 28 in this embodiment is approximately 5 inches. As seen in FIG. 4, the width W is at most substantially equal to the base plate width. As a result, the width W, as measured across the widest portion of the saw 20 is 5 inches or less.

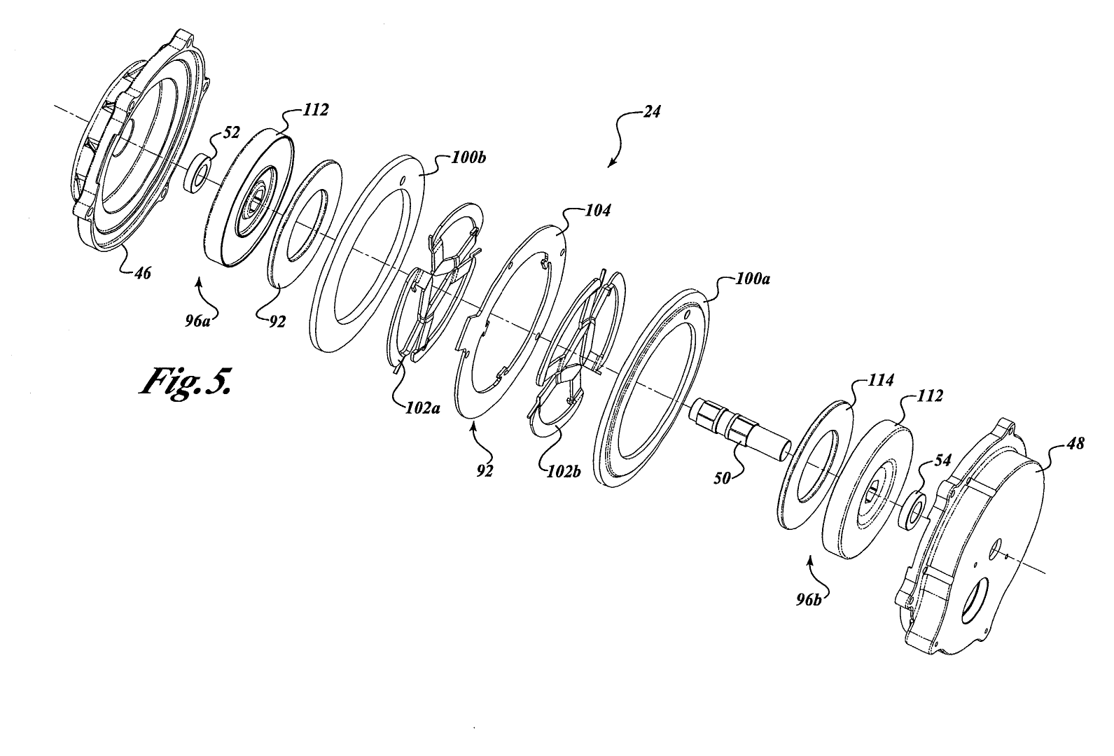

As may be best seen by referring to FIGS. 5 and 6, the motor assembly 24 includes a stator assembly 92, and first and second rotor assemblies 96a and 96b. It should be apparent that the terminology inner, outer, etc., should be construed as descriptive, and not limiting. Further, although the motor assembly 24 as illustrated has a rotor-stator-rotor configuration, it should be apparent that other types of motors, such as motors having two stators, are also within the scope of the present invention.

The stator assembly 92 includes inner and outer housings 100a and 100b, first and second coil windings 102a and 102b, and a printed circuit board 104. The inner and outer housings 100a and 100b are suitably formed as annular members from a thermally conductive material, such as a epoxy or plastic material. Although the housings 100a and 100b are illustrated as annular members, it should be apparent that other configurations, such as a multi-piece design or a one piece overmolding, are also within the scope of the present invention.

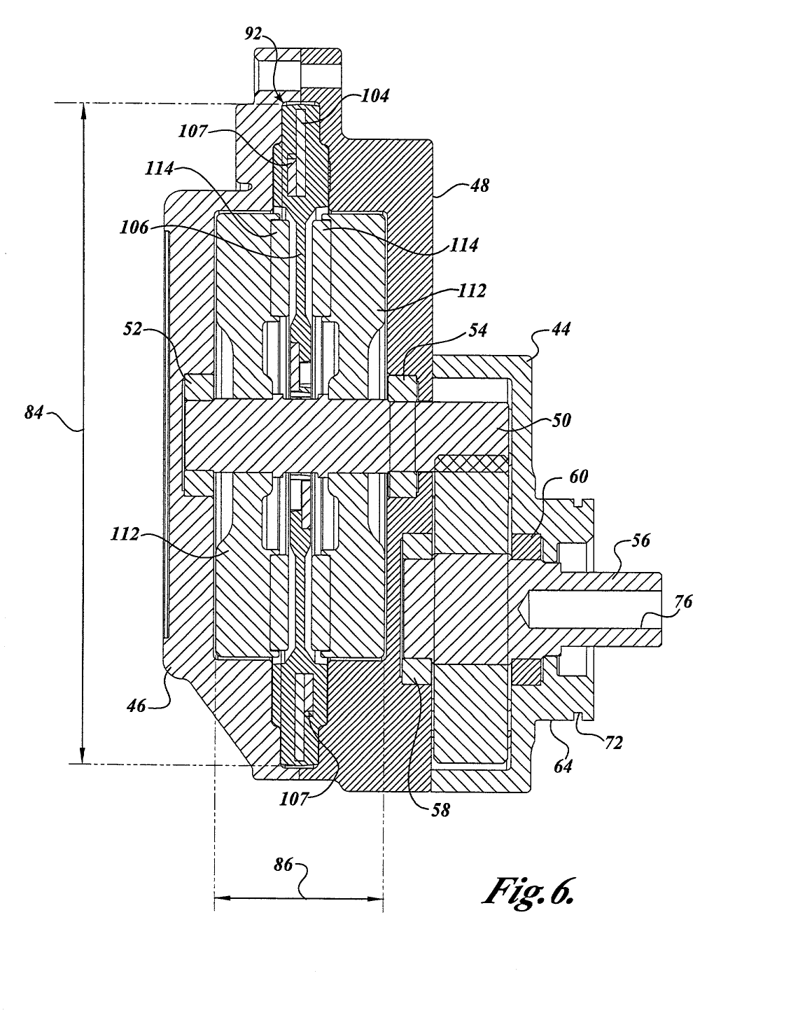

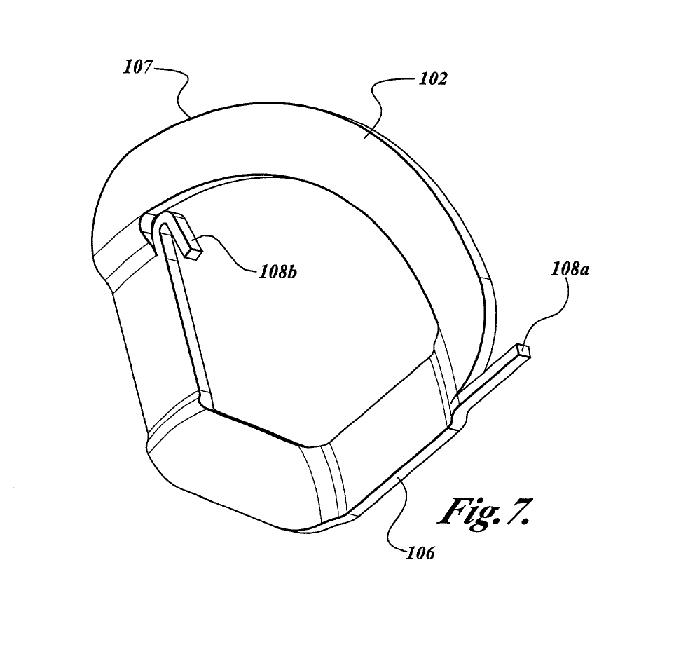

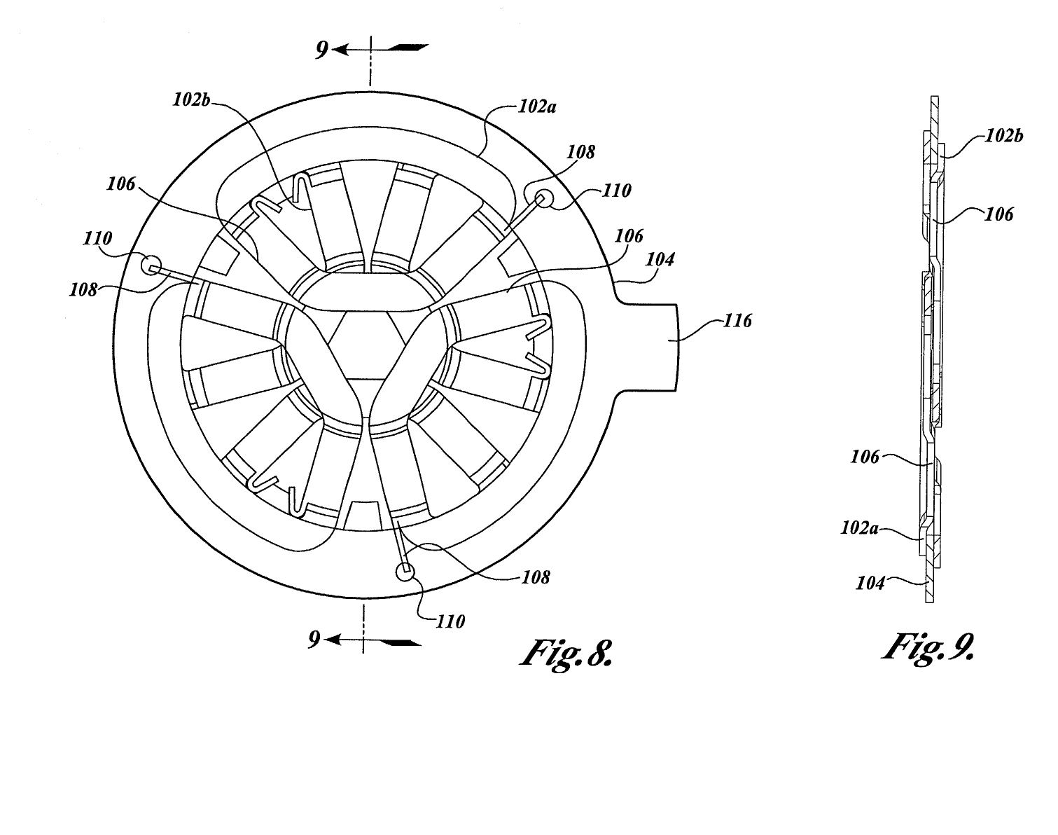

As may be best seen by referring to FIGS. 7 and 8, each of the first and second coil windings 102a and 102b include an indentation portion 106. The indentations of the first coil winding 102a are sized to be nested within the second coil winding 102b, such that the indentation portions 106 of the first and second coil windings 102a and 102b lie substantially in a common plane. The nested nature of the coil windings 102a and 102b is shown and described in U.S. Pat. No. 5,744,896, issued to Kessinger et al., the disclosure of which is hereby expressly incorporated by reference.

The interlocking arrangements of the first and second coil windings 102a and 102b provides the motor assembly 24 with a greater power density than other axial gap permanent magnet motors known in the art. As noted above, the motor assembly 24 generates a power rate, as measured at arbor 56, is at least one horsepower. Further, the weight of the motor assembly 24 and, therefore, the saw 20 is reduced because the required power is produced by a motor that is smaller than the size of a conventional motor of equal horsepower.

Alternatively, a sealed motor may be utilized in certain embodiments of the present invention. The enclosures of motor, includes a means for exchanging heat produced within the motor assembly 24. The coils are overmolded with a moldable material such as epoxy or plastic to form the stator assembly 92. The moldable material of stator assembly 92 may also be a thermally conductive material. Heat generated by an electrical current passing through the coils is transferred to the stator assembly 92. Stator assembly 97 transfers the heat to motor shells 46 and 48. The motor shells 46 and 48 accumulate the heat from the stator assembly, dissipate a portion of the heat to the environment, and transfer a portion of the heat to other interfacing parts of saw 20 such as housing 32, gear cover 44, and lower blade guard. These parts accumulate the heat and then dissipate a portion to the environment. Motor shells 46 and 48, blade housing 32, and lower blade guard are preferably formed of a thermally conductive alloy such as magnesium or aluminum. Gear cover 44 is preferably comprised of steel to rigidly support arbor 56, steel being also thermally conductive.

Referring back to FIG. 5, the first and second rotor assemblies 96a and 96b each include a rotor plate 112 and a magnet 114. As a non-limiting example, the magnets 114 may be configured as an annular array of permanent magnets. The magnets 114 of the annual array have their magnetic poles on an axis parallel to the motor output shaft 50. The magnetic poles alternate polarity with respect to each other around the array. A suitable number of magnets is four and, together, the magnets form a flat ring that is attached on the side of the rotors 112 and face the stator assembly 92. Each of the four magnets of the arrangement has a non-magnetic partition radially separating the magnets 114 of the annual array. The magnets 114 are suitably formed from a rare earth alloy, such as neodymium, iron, and boron alloy.

The coil windings 102a and 102b may be wound from a single length of wire and include an outer coil lead 108a and an inner coil lead 108b. The coil windings 102a and 102b are configured so that a pair of radially extending indentation portions 106 is in a plane separate from a pair of circumferential ends 107. As seen best in FIG. 8, there are six coils total when the first and second coil windings 102a and 102b are connected to the printed circuit board 104. The radially extending indentation portions 106 of the overlapped coils are co-planar, thereby forming the working coil portion of the stator assembly 92. Although six coils are illustrated and described, it should be apparent that motor assemblies with more or fewer coils, such as ten coils or four coils, are also within the scope of the present invention.

The printed circuit board 104 is sandwiched between the first and second coil windings 102a and 102b, such that the inner and outer coil leads 108a and 108b of each coil winding 102a and 102b are in electrical communication with a corresponding node 110 of the printed circuit board 104. The nodes 110 of the printed circuit board 104 are connected to the outer and inner coil leads 108a and 108b, in a well known manner thereby connecting the coil leads to conductors. The conductors connect the coil leads 108a and 108b to a number of motor control terminals (not shown) on connection tab 116 of the printed circuit board 104.

The printed circuit board 104 stiffens the stator assembly 92 against axial deflection during operation of the motor. The printed circuit board 104 also increases the accuracy and efficiency of the motor assembly 24 by holding the individual coils in place during assembly and by simplifying the connection of the motor assembly 24 to the electronics of the circular saw 20.

The connection tab 116 projects through a slot in the outer motor shell 46 and the inner motor shell 48 into the electronics compartment 41, where it connects to well known electronic communication and operating assembly. The electronic communication and operating assembly includes a silicon chip or an array of silicon chips that digitally control a distribution of electrical energy to the coils to drive the motor. Such chip or chips are preferably mounted on a circuit board inside the electronics compartment 41.

As noted above, the power source is battery pack 38. Another embodiment of saw 20 has the power source from a rectifier energized by an AC current. As is known, the rectifier converts AC current to a DC current at the proper voltage for the motor being driven. For the present invention, the rectifier can be mounted within saw 20 such as in handle assembly 34 or in a separate unit that replaces the battery pack 38.

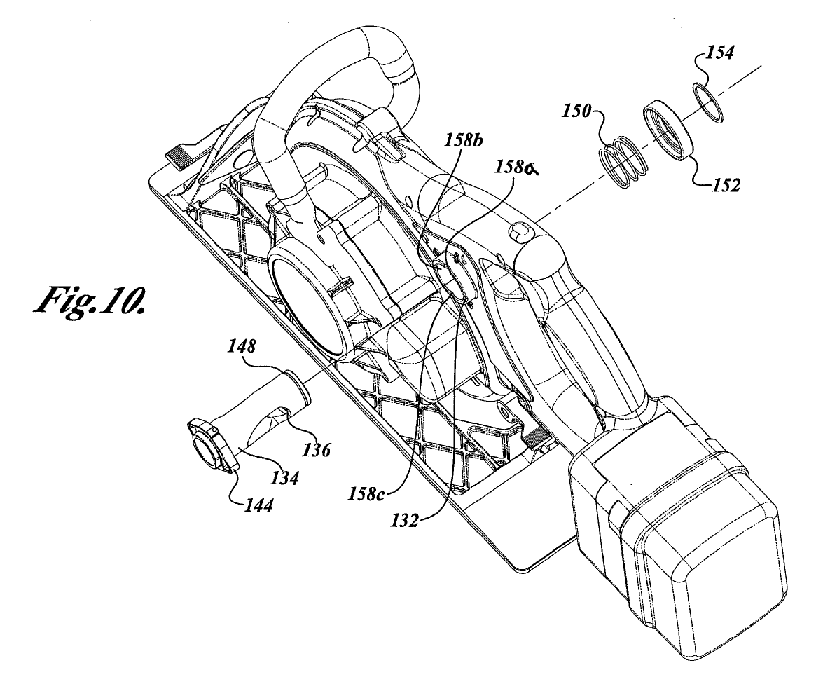

FIGS. 10-12 illustrate a selectable discharge assembly 130 formed in accordance with one embodiment of the present invention. The discharge assembly 130 includes a channel extending from within blade cover 32 of the housing 22 to a second channel 132 extending transversely through the integral handle assembly 34. As configured, the first channel extending through the housing 22 is in communication with the second channel 132, such that debris, such as sawdust, is channeled upward into the second channel 132.

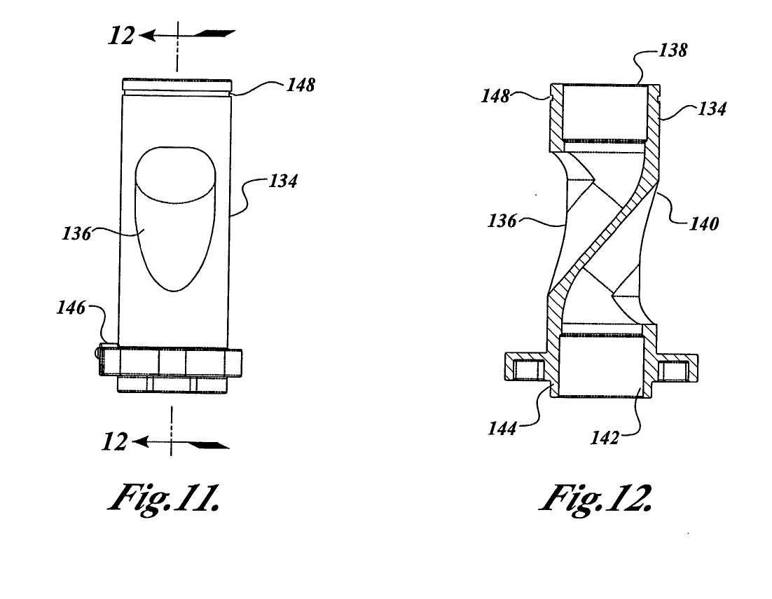

The selectable discharge assembly 130 also includes a bifurcated valve 134. As seen best by referring to FIGS. 11 and 12, the valve 134 includes a first port 136 connected to a first open end 138 and a second port 140 connected to a second open end 142. The valve 134 also includes a selector dial 144 with a detent post 146 integrally formed on the inner side of the selector dial 144. A retainer clip groove 148 is formed on the other end of the valve 134. The valve 134 is rotatably received within the second channel 132 and is retained therein by a tension spring 150, a valve retainer ring 152, and a valve retainer clip 154. A radially extending flange 156 extends outwardly from one end of the second channel 132, and includes detent notches 158a-158c. The detent notches 158a-158c are adapted to cooperate with the detent post 146 to indicate the position of the valve 134 and the direction of exhaust from within the saw 20.

The valve 134 is held within chamber 132 by the spring 150 trapped by the ring 152 that is retained on valve 134 by the clip 154 resting in groove 148. Selector dial 144 is tensioned by the force of spring 150 so that detent post 146 positively and selectively engages detent notches 158a-158c. The detent notches 158a-158c are arranged so that rotation of the valve 134 to a first detent position directs dust flowing from the second channel 132 into the first port 136 and out the first open end 138. Rotation of the valve 134 to a second detent position directs dust flowing from the second channel 132 into the second port 140 and out the second open end 142.

The first and second open ends 138 and 140 may be disposed at a variety of locations on the housing 22. As a non-limiting example, one of the first and second open ends 138 and 140 may be disposed on the left and right sides, respectively, of the housing 22, thereby channeling saw dust accordingly. When the dial 144 is in the third position or detent, saw dust may be channeled through the bottom of the base plate 28.

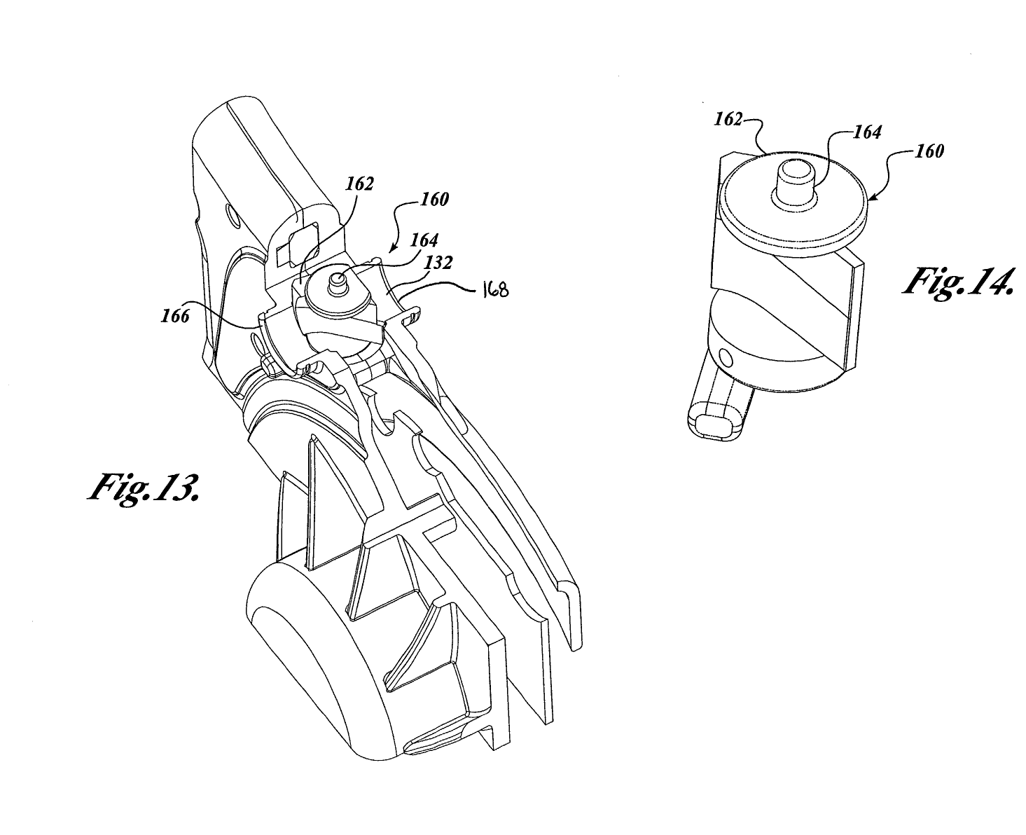

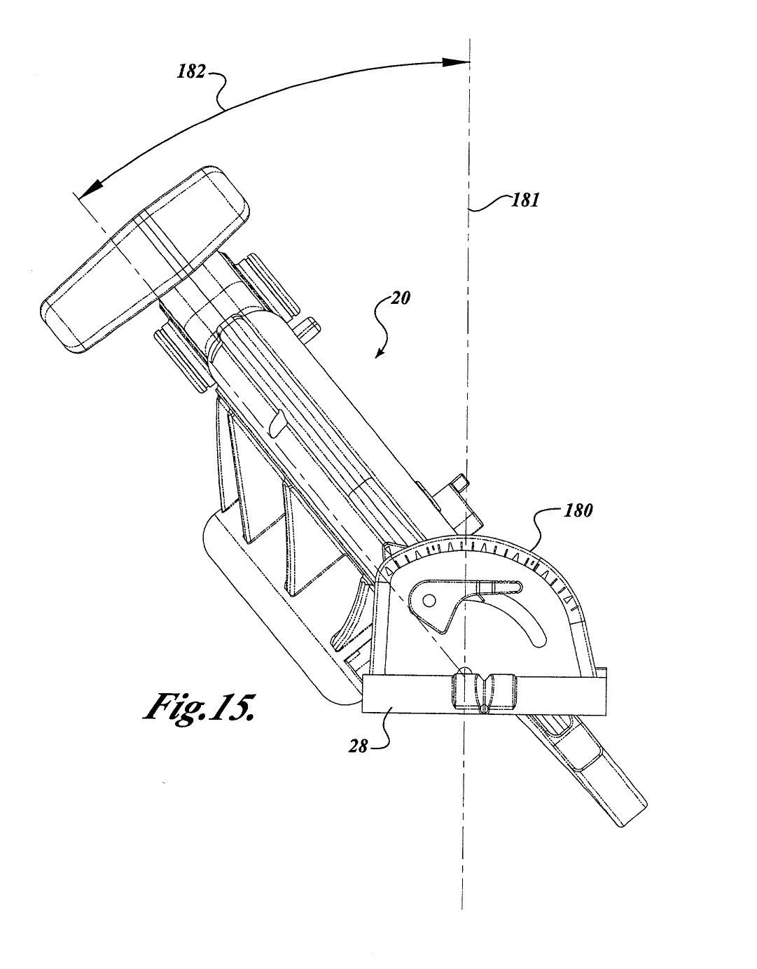

Referring to FIGS. 13 and 14, a second embodiment of the selectable direction dust discharge device 160 is disclosed. The device 160 operates to divert saw dust to one of two positions; through the right or left sides of the housing 22. The second channel 132 supports a contoured vane 162 vertically positioned within channel 132 and moved by a push rod 164. The vane 162 and the push rod 164 having a first position to deflect dust out a first opening 166 in the channel 132. The vane 162 and the push rod 164 having a second position to deflect dust out a second opening 168 in the channel 132.

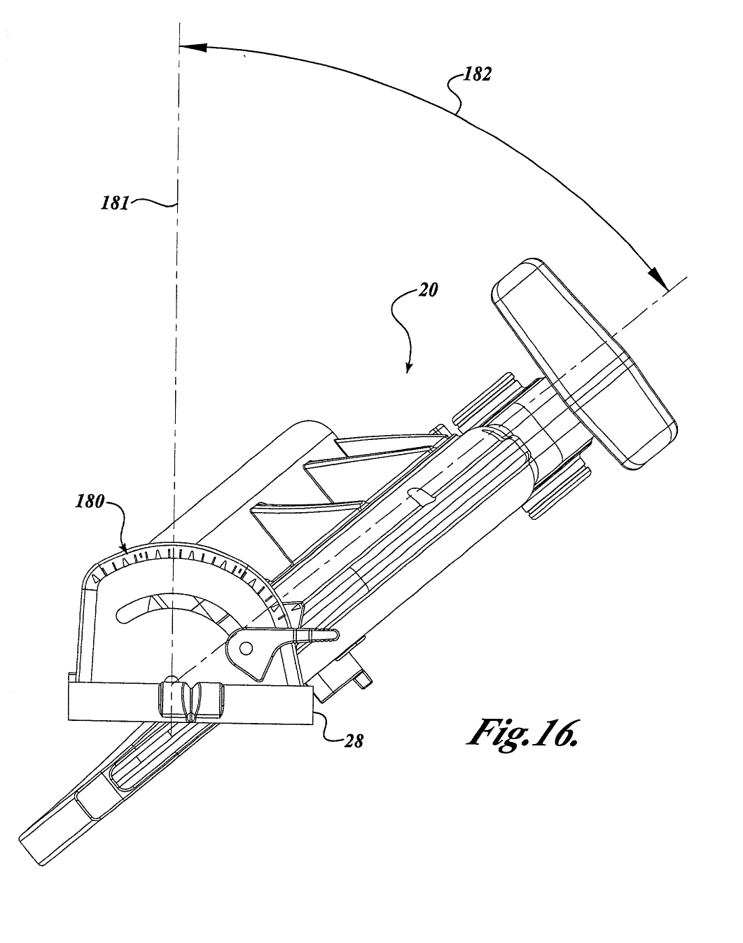

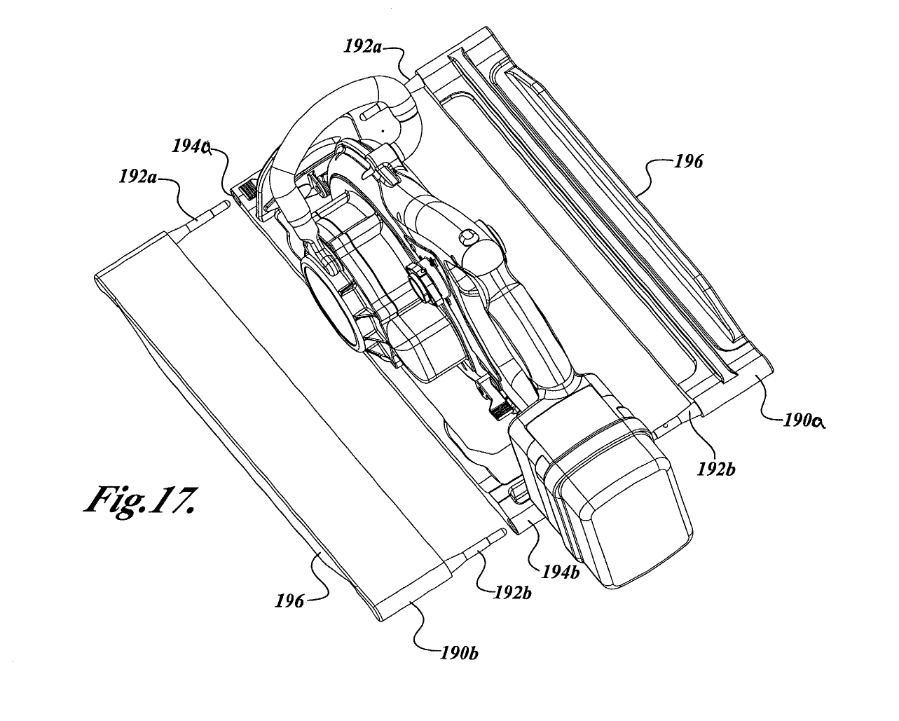

FIGS. 15 and 16 illustrate a blade angle change bracket 180. Because the width of the motor assembly 24 and housing 22 is no greater than the width of the base plate 28, the saw 20 may be configured such that it is pivotably to both sides of the base plate 28. The bracket 180 allows the user to select any angle 182 that can be defined by a plane 181 perpendicular to the width of the base plate 28. Angle 182 preferably has a range adjustment of substantially +51° from the plane 181, as shown in FIG. 16, to substantially −40° from the plane 181, as shown in FIG. 15.

FIG. 17 includes first and second shoe extensions 190a and 190b. In some instances the user may have need of a base plate 28 that is wider than the one attached to saw 20. This could especially be true where the maximum width of the circular saw 20 is less than five inches. The shoe extensions 190a and 190b are adapted to be removeably fastened to the base plate 28. Each shoe extension 190a and 190b includes at least two protruding members 192a and 192b that are removably received into mating apertures 194a and 194b located on at least one side of the base plate 28. Although FIG. 17 illustrates first and second shoe extensions 190a and 190b, only one shoe extension may be used to effectively extend the width of the base plate 28. Further, either one or both of the shoe extensions 190a and 190b may include an upwardly extending flange 196. The flange 196 may be used as a rip guide, such that the shoe extension may be turned upside down and inserted into its corresponding aperture, thereby extending the flange 196 downwardly from the base plate 28. As such, the shoe extension may be used as a rip guide.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A power tool, comprising:
(a) a housing;
(b) a base plate coupled to the housing and having a base plate width; and
(c) a motor assembly attached to the housing and coupled to a tool connector adapted to releasably receive a tool, the motor assembly and housing having a width no greater than the base plate width, the motor assembly having a length to diameter ratio that is at least 1:1.5.

2. The power tool of claim 1, wherein the motor assembly length and diameter is substantially one inch and 4.5 inches, respectively.

3. The power tool of claim 1, wherein the base plate width is substantially five inches.

4. The power tool of claim 1, wherein the motor assembly and housing are pivotably attached to the base plate for selective swinging motion of the motor assembly and housing between a predetermined range of motion.

5. The power tool of claim 4, wherein the predetermined range of motion is substantially between +51° from a plane extending normal to the base plate width and −40° from the plane.

6. The power tool of claim 4, wherein the predetermined range of motion is substantially between a plane extending normal to the base plate width and up to 50° from the plane.

7. The power tool of claim 1, wherein the motor comprises a printed circuit board disposed between first and second coil assemblies.

8. The power tool of claim 7, wherein each coil assembly having a plurality of coils, where adjacent coils are nested within each other.

9. The power tool of claim 8, wherein the printed circuit board includes a plurality of coil connections in communication with the plurality of coils.

10. The power tool of claim 1, further comprising an adjustable exhaust assembly integrally formed with the housing.

11. The power tool of claim 10, wherein the adjustable exhaust assembly is rotatably disposed within the housing and positionable between at least two exhaust positions.

12. The power tool of claim 11, wherein the adjustable exhaust assembly is rotatably disposed within the housing and positionable between a left exhaust position, a right exhaust position and a center exhaust position.

13. The power tool of claim 1, further comprising a first base plate extension removably fastened to the base plate.

14. The power tool of claim 13, further comprising a second base plate extension removably fastened to the base plate.

15. The power tool of claim 14, wherein at least one of the first and second extensions includes a flange extending from the first or second extension to permit the shoe extension to be used as a rip guide.

16. A power circular saw, comprising:
(a) a housing;
(b) a base plate having a width and fastened to the housing; and
(c) a motor assembly attached to the housing and coupled to a tool connector adapted to releasably receive a saw blade, the motor assembly and housing having a width no greater than the base plate width, the motor assembly having a length to diameter ratio that is at least 1:1.5.

17. The power circular saw of claim 16, wherein the motor assembly length and diameter is substantially one inch and 4.5 inches, respectively.

18. The power circular saw of claim 16, wherein the base plate width is substantially five inches.

19. The power circular saw of claim 16, wherein the motor assembly and housing are pivotably attached to the base plate for selective swinging motion of the motor assembly and housing between a predetermined range of motion.

20. The power circular saw of claim 16, wherein the motor comprises a printed circuit board disposed between first and second coil assemblies.

21. The power circular saw of claim 20, wherein each coil assembly having a plurality of coils, where adjacent coils are nested within each other.

22. The power circular saw of claim 16, further comprising an adjustable exhaust assembly integrally formed with the housing.

23. The power circular saw of claim 16, further comprising a first base plate extension removably fastened to the base plate.

24. A power circular saw, comprising:
(a) a housing;
(b) a base plate having a width and fastened to the housing; and
(c) a motor assembly attached to the housing and coupled to a tool connector adapted to releasably receive a saw blade having a diameter, the motor assembly and housing having a width no greater than the base plate width, the motor assembly having a length to diameter ratio that is at least 1:1.5, the motor comprising an output shaft having a length, wherein the motor is attached to the housing such that an axis extending through the length of output shaft is within the diameter of the saw blade.

25. A power circular saw, comprising:
(a) a housing;
(b) a base plate having a width of five inches and fastened to the housing; and
(c) a motor assembly attached to the housing and coupled to a tool connector adapted to releasably receive a saw blade, the motor assembly and housing having a width no greater than the base plate width, the motor assembly having a length to diameter ratio that is at least 1:1.5.

26. A power circular saw, comprising:
(a) a housing;
(b) a base plate having a width and fastened to the housing; and
(c) a motor assembly attached to the housing and coupled to a tool connector adapted to releasably receive a saw blade, the motor assembly and housing having a width no greater than the base plate width, the motor assembly comprising:
(i) first and second rotor assemblies; and
(ii) a stator assembly disposed between the first and second rotor assemblies, the stator assembly having a printed circuit board disposed between a plurality of nested coil windings, the motor assembly having a having a length to diameter ratio that is at least 1:1.5.
